(19) United States
(12) Patent Application Publication
(10) Pub. No.: US 2015/0307022 A1
(43) Pub. Date: Oct. 29, 2015

(54) HAPTIC STEERING WHEEL

(71) Applicant: Ford Global Technologies, LLC, Dearborn, MI (US)

(72) Inventor: Zachary David Nelson, Detroit, MI (US)

(73) Assignee: Ford Global Technologies, LLC, Dearborn, MI (US)

(21) Appl. No.: 14/259,653

(22) Filed: Apr. 23, 2014

(51) Int. Cl. B60Q 9/00; B62D 1/06

(52) U.S. Cl. CPC B60Q 9/00; B62D 1/06

(57) ABSTRACT

At least one location of an operator's hand on a vehicle steering wheel is detected. One or more haptic devices may be actuated in the steering wheel to provide a message to the operator, the one or more haptic devices selected for actuation being determined according to the at least one location.

### BACKGROUND

Various vehicle systems may be configured to generate messages, alerts, etc. that may be provided to a vehicle operator. For example, a message or alert could be related to vehicle safety, e.g., a warning of a possible collision, of dangerous road conditions, etc. Unfortunately, present mechanisms for providing messages or alerts, including related to driver safety may distract a vehicle operator, e.g., by forcing the vehicle operator to view a display in the vehicle. Other mechanisms, such as a vibrating steering column, are insufficient for providing precise information to a vehicle operator concerning a vehicle condition or safety risk. Accordingly, there is a need for improved systems and methods for communicating vehicle messages and warning to a vehicle operator.

### DRAWINGS

FIG. 1 is a block diagram of an exemplary haptic steering wheel system.

FIG. 2 is a front view of a steering wheel including touch sensors.

FIG. 3 is a side view of a steering wheel including touch sensors.

FIG. 4 is a front cutaway view of a portion of a steering wheel including touch sensors and haptic devices.

FIG. 5 is a diagram of an exemplary process for provides haptic messages via a vehicle steering wheel.

### DETAILED DESCRIPTION

### System Overview

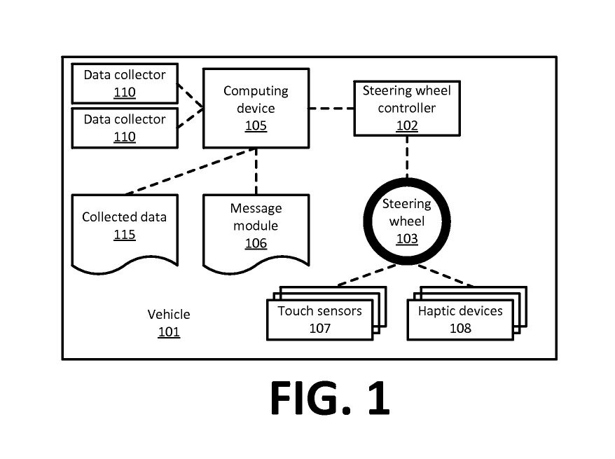

FIG. 1 is a block diagram of an exemplary haptic steering wheel system. A plurality of touch sensors 107 are embedded in a vehicle 101 steering wheel 103. A plurality of haptic feedback devices 108 are also embedded in the steering wheel 103. The sensors 107 can be used to detect a vehicle 101 driver's hand position on the steering wheel 103, whereby haptic (vibration) feedback may be provided at a location of the drivers hand or hands on the steering wheel 103. For example, various vehicle data collectors 110 in addition to the sensors 107, i.e., sensors and the like, may provide collected data 115 to a vehicle 101 computer 105. A message module 106 comprising instructions stored in a memory of the computer 105 may determine, based on data 115, that a message should be provided via the steering wheel 103, whereby the computer 105 may communicate with a steering wheel controller 102 to actuate one or more of the haptic devices, e.g., according to a position of a driver's hand(s) on the steering wheel 103 and/or according to a specific message being provided.

Accordingly, the vehicle 101 may be provided with a useful human-machine interface (HMI) mechanism in addition to existing HMI components such as audio output mechanisms, visual display mechanisms, etc. Instead of using the steering wheel 103 solely for steering the vehicle 101, presently disclosed systems and methods provide for vehicle 101 driver alerts or messages on the steering wheel 103 using the haptic feedback.

### Exemplary System Elements

The vehicle 101 computer 105 generally includes a processor and a memory, the memory including one or more forms of computer-readable media, and storing instructions executable by the processor for performing various operations, including as disclosed herein. Further, the computer 105 may include more than one computing device, e.g., controllers or the like included in the vehicle 101 for monitoring and/or controlling various vehicle components, e.g., an engine control unit (ECU), transmission control unit (TCU), etc.

The computer 105 is generally configured for communications on a controller area network (CAN) bus, via Local Interconnect Network (LIN) protocol, or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including steering wheel controller 102, touch sensors 107, and data collectors 110. Alternatively or additionally, in cases where the computer 105 actually comprises multiple devices, the CAN bus or the like may be used for communications between devices represented as the computer 105 in this disclosure. In addition, the computer 105 may be configured for communicating with the network 120, which, as described below, may include various wired and/or wireless networking technologies, e.g., cellular, Bluetooth, wired and/or wireless packet networks, etc.

Communications, including instructions to actuate a device may include a message sent, e.g., via a CAN, LIN, etc., to a controller 102 of devices 108 that cause haptic feedback, e.g., vibration, to be provided via the steering wheel 103. The controller 102 generally includes a processor and a memory, and is configured to send and receive communications to and from the computer 105, as well as to output instructions to the haptic devices 108.

Touch sensors 107 may include one or more sensing device that could be used to detect if a driver's hands were on the steering wheel 103 and/or a position or location of the driver's hands on the steering wheel 103. For example, sensors 107 could be optical, infrared, resistive, capacitive, surface acoustic wave, and/or thermal sensors 107. Alternatively or additionally, one or more camera data collectors 110 could be used to provide image data 115 to indicate a presence and/or location of a driver's hand or hands on the steering wheel 103.

Haptic devices 108 are generally known, e.g., for use in portable electronic devices such as cellular telephones and the like. In general, a haptic device 108 includes a vibration motor or the like (e.g., a coil or speaker mechanism) that may be controlled by the controller 102 in order to provide vibrations of a specified strength and/or frequency specified for a haptic alert or message.

As mentioned above, generally included in instructions stored in and executed by the computer 105 is a message module 106. Using data 115 received in the computer 105, e.g., from data collectors 110, the module 106 may generate a message, e.g., an alert, to be provided via the haptic devices 108 embedded in or on the steering wheel 103. For example, collected data 115 could indicate that a vehicle 101 was exceeding a posted speed limit by a predetermined amount, whereupon the module 106 could determine to provide haptic output via the devices 108, e.g., a short vibration or vibrations to warn a vehicle 101 driver that a vehicle 101 speed was too high. Likewise, collected data 115 could indicate that a vehicle 101 was in danger of colliding with another object, e.g., a second vehicle, whereupon the module 106 could determine to provide different haptic output via the devices 108, e.g., longer and/or strong vibrations to warn of a possible collision. As mentioned above, a location of haptic output on the steering wheel 103 may be determined by a location of a driver's hand or hands on the steering wheel 103. Further, a location of haptic output may be determined by the nature of an alert, e.g., if the vehicle 101 was in danger of colliding with an object to the left of the vehicle 101, then a haptic device or devices on a left side of the steering wheel 103 could be actuated.

Data collectors 110 may include a variety of devices. For example, various controllers in a vehicle may operate as data collectors 110 to provide data 115 via the CAN bus, e.g., data 115 relating to vehicle 101 speed, acceleration, etc. Further, sensors or the like, global positioning system (GPS) equipment, etc., could be included in a vehicle 101 and configured as data collectors 110 to provide data directly to the computer 105, e.g., via a wired or wireless connection. Sensor data collectors 110 could include mechanisms such as RADAR, LIDAR, sonar, etc. sensors that could be deployed to measure a distance or closing rate between the vehicle 101 and other vehicles or objects. In addition, data collectors 110 may include sensors to detect a position, change in position, rate of change in position, etc., of vehicle 101 components such as a steering wheel, brake pedal, accelerator, gearshift lever, etc.

A memory of the computer 105 generally stores collected data 115. Collected data 115 may include a variety of data collected in a vehicle 101. Examples of collected data 115 are provided above, and moreover, data 115 is generally collected using one or more data collectors 110, as well as the touch sensors 107, and may additionally include data calculated therefrom in the computer 105. In general, collected data 115 may include any data that may be gathered by a collection device 110, a sensor 107, and/or computed from such data. For example, collected data 115, as mentioned above, may include data concerning a position, change in position, rate of change in position, etc., of vehicle 101 components such as a steering wheel, brake pedal, accelerator, gearshift lever, etc.

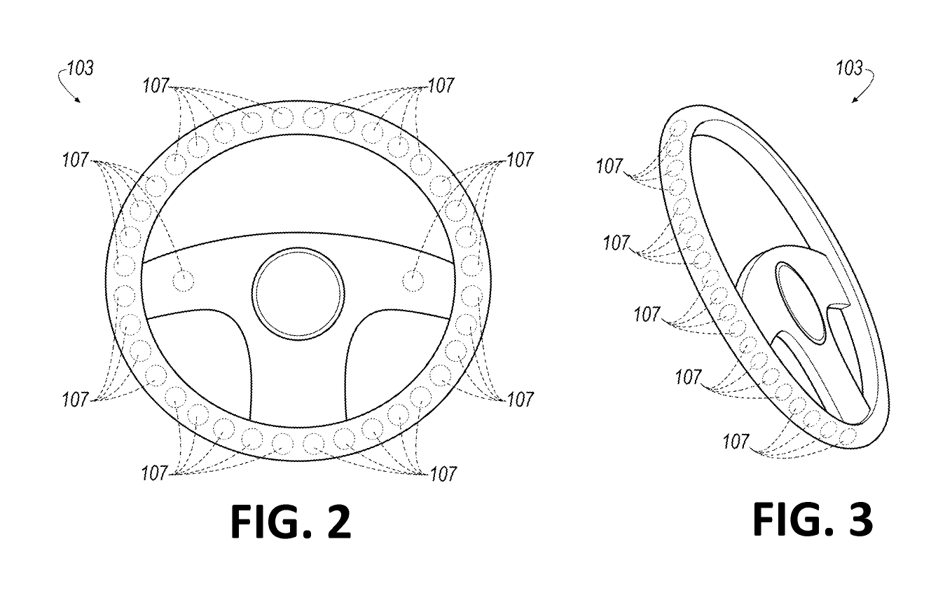

FIG. 2 is a front view of a steering wheel 103 including touch sensors 107. FIG. 3 is a side view of a steering wheel 103 including touch sensors 107. As can be seen in FIGS. 2 and 3, the touch sensors 107 are arranged so as to detect a position of a driver hand or hands on the steering wheel 103 with respect to practically all of a front, rear, and/or side surfaces of the steering wheel 103, e.g., sensors 107 may cover most or practically all of the areas of the steering wheel 103 that some or all of a driver's hand or hands may cover.

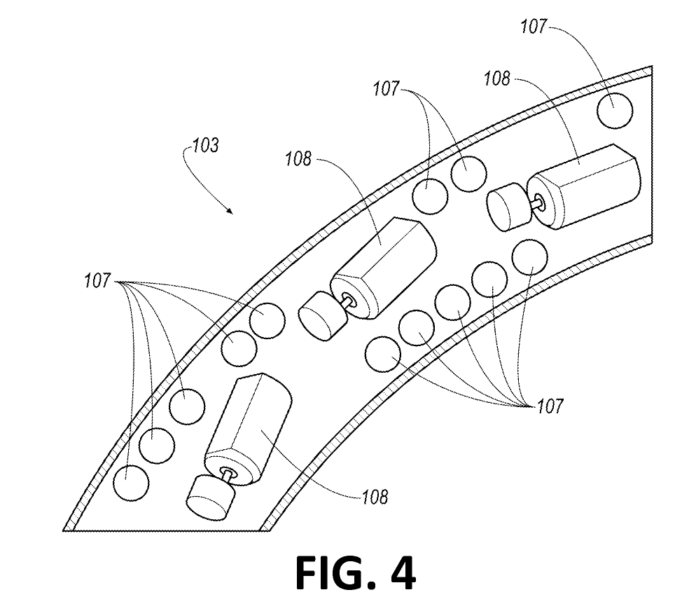

Haptic devices 108 are not shown in FIGS. 2 and 3 for ease of illustration. However, FIG. 4 is a front cutaway view of a portion of a steering wheel 103 including touch sensors 107 and haptic devices 108. As can be seen in FIG. 4, haptic devices 108 are generally embedded in the steering wheel 103 with sufficient proximity to one another to provide coverage for all or practically all of a circumference of the steering wheel 103. For example, in one implementation, haptic devices 108 are embedded in the steering wheel 103 approximately ½ inch apart from one another. Touch sensors 107 may be that close or closer to one another. Further, although not illustrated in FIG. 4, it is to be understood that, like the sensors 107, haptic devices 108 could be embedded in steering wheel 103 spokes or the like. Moreover, a touch sensor 107 and a haptic device 108 may occupy a same location with respect to a surface of the steering wheel 103. That is, a haptic device 108 may be embedded deeper in the steering wheel 103, whereas the sensor 107 may be at or closer to the steering wheel 103 surface.

### Exemplary Process Flows

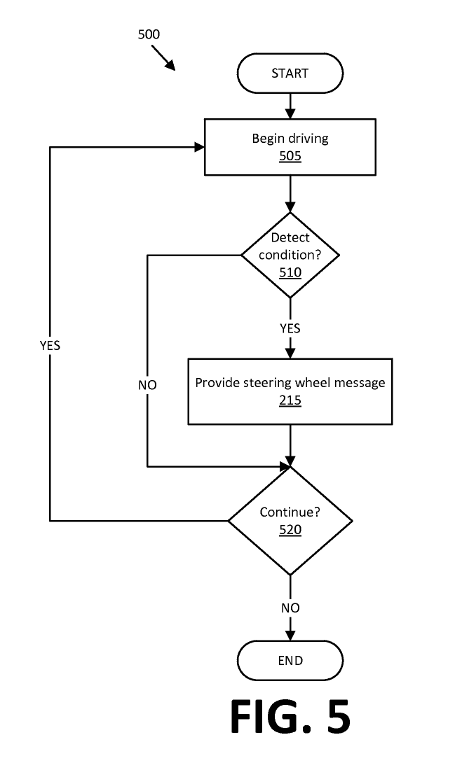

FIG. 5 is a diagram of an exemplary process 500 for providing haptic messages via a vehicle steering wheel. The process 500 begins in a block 505, in which the vehicle 101 commences driving operations in which data 115 is collected from sensors 107 and data collectors 110.

Next, in a block 210, the computer 105 determines whether a condition has been detected concerning which a message or alert should be provided to a human operator via a vehicle 101 steering wheel 103. For example, as mentioned above, collected data 115 may indicate a variety of such conditions, such as the vehicle 101 being in a restricted lane or off of a roadway, a hazardous driving surface, an obstacle or potential collision, a deviation from a path planned by a navigation system, etc. If such condition is detected, then the process 500 proceeds to a block 515. Otherwise, the process 500 proceeds to a block 520.

In the block 515, the computer 105 sends an instruction, e.g., via a CAN bus or the like, to a controller 102 configured to actuate one or more haptic devices 108 in the steering wheel 103. As mentioned above, the computer 105 may instruct the controller 102 to actuate the one or more devices 108 in a manner appropriate for an alert or message being provided. For example, a frequency and strength of vibrations, a number of devices 108 actuated, etc., may be determined according to a nature or urgency of a message. For example, relatively weak vibrations, or a low number of vibrations, or vibrations of a short duration, may be used for lower priority messages, e.g., relating to vehicle speed or the like. Relatively stronger vibrations, a higher number of vibrations, and/or vibrations of a longer duration, may be used for higher priority messages, e.g., relating to a possible collision, the vehicle 101 veering off a roadway or otherwise deviating from a roadway lane, etc. As also mentioned above, a particular device or devices 108 that the computer 105 instructs a controller 102 to actuate may be determined on a location of a driver's hand or hands on a steering wheel 103. Accordingly, it is not necessary to vibrate or move an entire steering column or entire steering wheel, but instead a localized haptic message may be provided that both effectively alerts a driver without unduly disturbing driving operations and/or a driver's attention, i.e., the steering column control modules then can provide specific haptic feedback based on the driver hand (or hands) position.

Yet further, as also mentioned above, a device or devices 108 could be selected for actuation in the steering wheel 103 according to a location in the steering wheel 103 related to a message to be provided. For example, an indication that a cellular phone was receiving a call could always result in actuation of a haptic device 108 on a right side of the steering wheel 103. Likewise, an indication that fuel levels were low could always result in actuation of a haptic device 108 on a left side of the steering wheel 103. Also, a location of a haptic device 108 that is actuated could be related to a message being conveyed, e.g., a risk of collision on a left side of a vehicle could result in actuation of a haptic device 108 on a left side of the steering wheel 103.

In the block 230, which may follow either of the blocks 510, 515, the computer 105 determines whether driving operations are to be continued. For example, user input could be received indicating that driving operations are to be terminated, a vehicle 101 could be powered off, etc. If driving operations are to be continued, then the process 500 returns to the block 505. Otherwise, the process 500 ends.

### Conclusion

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer in a vehicle, configured to:
instruct actuation of one or more haptic devices in a steering wheel to provide a message to a vehicle operator, the one or more haptic devices selected for actuation being determined according to one of a detected location of the operator's hand on the steering wheel and detected respective locations of the operator's hands on the steering wheel.

2. The system of claim 1, wherein the computer is further configured to receive data relating to operation of the vehicle.

3. The system of claim 2, wherein the one or more haptic devices selected for actuation is also determined according to the message, the message being based on the data relating to operation of the vehicle.

4. The system of claim 2, wherein the data relating to operation of the vehicle includes at least one of a vehicle speed, a vehicle risk of collision with an object, an indication that the vehicle is deviating from a planned route, an indication that the vehicle is deviating from a roadway lane, and an indication of a hazardous driving surface.

5. The system of claim 1, wherein the computer is further configured to select the one or more haptic devices for actuation according to a location of each of the one or more haptic devices on the steering wheel.

6. The system of claim 1, wherein the message provides an indication that a cellular telephone is being contacted.

7. The system of claim 1, wherein at least one of a capacitive sensor, a resistive sensor, a thermal sensor, an optical or infrared sensor, a surface acoustic wave sensor, and a camera is used to detect a location of a driver's hand on the steering wheel.

8. A method, comprising:
detecting at least one location of an operator's hand on a vehicle steering wheel; and
instructing actuation of one or more haptic devices in the steering wheel to provide a message to the operator, the one or more haptic devices selected for actuation being determined according to the at least one location.

9. The method of claim 8, further comprising receiving data relating to operation of the vehicle.

10. The method of claim 9, wherein the one or more haptic devices selected for actuation is also determined according to the message, the message being based on the data relating to operation of the vehicle.

11. The method of claim 9, wherein the data relating to operation of the vehicle includes at least one of a vehicle speed, a vehicle risk of collision with an object, an indication that the vehicle is deviating from a planned route, an indication that the vehicle is deviating from a roadway lane, and an indication of a hazardous driving surface.

12. The method of claim 8, further comprising selecting the one or more haptic devices for actuation according to a location of each of the one or more haptic devices on the steering wheel.

13. The method of claim 8, wherein the message provides an indication that a cellular telephone is being contacted.

14. The method of claim 8, wherein at least one of a capacitive sensor, a resistive sensor, a thermal sensor, an optical or infrared sensor, a surface acoustic wave sensor, and a camera is used to detect the at least one location of the operator's hand on the steering wheel.

15. A computer-readable medium having embodied thereon instructions executable by a computer processor, the instructions including instructions for:
detecting at least one location of an operator's hand on a vehicle steering wheel; and
instructing actuation of one or more haptic devices in the steering wheel to provide a message to the operator, the one or more haptic devices selected for actuation being determined according to the at least one location.

16. The medium of claim 15, the instructions further including instructions for receiving data relating to operation of the vehicle; wherein the one or more haptic devices selected for actuation is also determined according to the message, the message being based on the data relating to operation of the vehicle.

17. The medium of claim 16, wherein the data relating to operation of the vehicle includes at least one of a vehicle speed, a vehicle risk of collision with an object, an indication that the vehicle is deviating from a planned route, an indication that the vehicle is deviating from a roadway lane, and an indication of a hazardous driving surface.

18. The medium of claim 15, the instructions further including instructions for selecting the one or more haptic devices for actuation according to a location of each of the one or more haptic devices on the steering wheel.

19. The medium of claim 15, wherein the message provides an indication that a cellular telephone is being contacted.

20. The medium of claim 15, wherein at least one of a capacitive sensor, a resistive sensor, a thermal sensor, an optical or infrared sensor, a surface acoustic wave sensor, and a camera is used to detect the at least one location of the operator's hand on the steering wheel.
